(19) United States
(12) Patent Application Publication
(10) Pub. No.: US 2024/0070793 A1
(43) Pub. Date: Feb. 29, 2024

(54) ORDER RECEPTION SYSTEM, ORDER RECEPTION METHOD, AND STORAGE MEDIUM

(71) Applicant: TOYOTA JIDOSHA KABUSHIKI KAISHA, Toyota-shi (JP)

(72) Inventors: Taizo MASUDA, Yokohama-shi (JP); Kiyoto SASAKI, Susono-shi (JP); Daisuke KAKUMA, Toyota-shi (JP); Hiroyoshi MASUI, Susono-shi (JP); Akihiro YAMAGUCHI, Toyota-shi (JP); Sokfan YEE, Toyota-shi (JP); Yuki NISHIKAWA, Numazu-shi (JP)

(73) Assignee: TOYOTA JIDOSHA KABUSHIKI KAISHA, Toyota-shi (JP)

(21) Appl. No.: 18/229,875

(22) Filed: Aug. 3, 2023

(30) Foreign Application Priority Data
Aug. 25, 2022 (JP) 2022-134215

(51) Int. Cl. G06Q 50/12; G06Q 10/02

(52) U.S. Cl. CPC G06Q 50/12; G06Q 10/02

(57) ABSTRACT

An order reception system according to the present disclosure includes one or more processors. The one or more processors are configured to perform receiving a reservation from a user to provide a dish to a dish providing place, receiving the reservation to provide a dish, calculating a lead time required for providing the dish and an arrival time at which the user arrives at the dish providing place, and instructing the dish providing place to start preparing to provide the dish based on the arrival time and the lead time.

### CROSS-REFERENCE TO RELATED APPLICATION

This application claims priority to Japanese Patent Application No. 2022-134215 filed on Aug. 25, 2022, incorporated herein by reference in its entirety.

### BACKGROUND

### 1. Technical Field

The present disclosure relates to a technique for receiving a reservation for providing a dish from a user to a providing place of the dish.

### 2. Description of Related Art

In recent years, in a case where a destination is searched for the purpose of travel, entertainment, or the like, many techniques have been considered for a technique of proposing an appropriate destination according to a request or an attribute of a user.

For example, Japanese Unexamined Patent Application Publication No. 2020-134953 (JP 2020-134953 A) discloses an information processing device including a control unit that executes specifying a facility corresponding to a user attribute including a user's needs, preferences, or characteristics, and outputting information on a facility that has not been visited from the specified facility to the user.

### SUMMARY

However, depending on the proposed destination, the user may not be able to receive a satisfactory service even when the user arrives at the destination. As described above, there is room for consideration to improve a satisfaction level of the user when the user arrives at the destination, and a further technique is required.

Particularly in a typical case, when the destination is a providing place of a dish such as a restaurant, the user has to wait for a long time after the user arrives at the destination since it takes time to provide the dish.

In view of the above issues, one object of the present disclosure is to provide a technique for reducing a waiting time of the user after arriving at the destination when the destination for the user is the providing place of the dish.

A first aspect relates to an order reception system.

The order reception system includes one or more processors.

The one or more processors are configured to perform:
receiving a reservation for providing a dish from a user to a providing place of the dish; calculating, in response to the reservation, a lead time required for providing the dish and an arrival time at which the user arrives at the providing place; and instructing the providing place to start preparation for providing the dish based on the arrival time and the lead time.

A second aspect relates to an order reception method.

The order reception method includes:
receiving a reservation for providing a dish from a user to a providing place of the dish; calculating, in response to the reservation, a lead time required for providing the dish and an arrival time at which the user arrives at the providing place; and instructing the providing place to start preparation for providing the dish based on the arrival time and the lead time.

A third aspect relates to a storage medium storing an order reception program.

The order reception program is configured to cause a computer to perform processes including:
receiving a reservation for providing a dish from a user to a providing place of the dish; calculating, in response to the reservation, a lead time required for providing the dish and an arrival time at which the user arrives at the providing place; and instructing the providing place to start preparation for providing the dish based on the arrival time and the lead time.

According to the present disclosure, the start of the preparation for providing the dish is instructed to the providing place of the dish based on the arrival time at which the user arrives at the providing place of the dish and the lead time required for providing the dish. As a result, it is expected that a provider of the dish starts preparing the dish according to the instruction, so that the dish can be provided around a time when the user arrives at the providing place of the dish. Accordingly, it is possible to reduce the waiting time after the user arrives at the providing place of the dish such as a restaurant.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of an order reception system according to the present embodiment;

FIG. 2 is a block diagram illustrating a configuration example of the order reception system according to the present embodiment;

FIG. 3 is a block diagram showing a configuration of the storage device shown in FIG. 2;

FIG. 4 is a flowchart illustrating an example of processing executed by the order reception device according to the present embodiment;

FIG. 5 is a flowchart illustrating an example of a part of processing executed by the order reception device according to the present embodiment;

FIG. 6 is a flowchart illustrating an example of a part of processing executed by the order reception device according to the present embodiment;

FIG. 7 is a flowchart illustrating an example of a part of processing executed by the order reception device according to the present embodiment.

### DETAILED DESCRIPTION OF EMBODIMENTS

### 1. Order Reception System

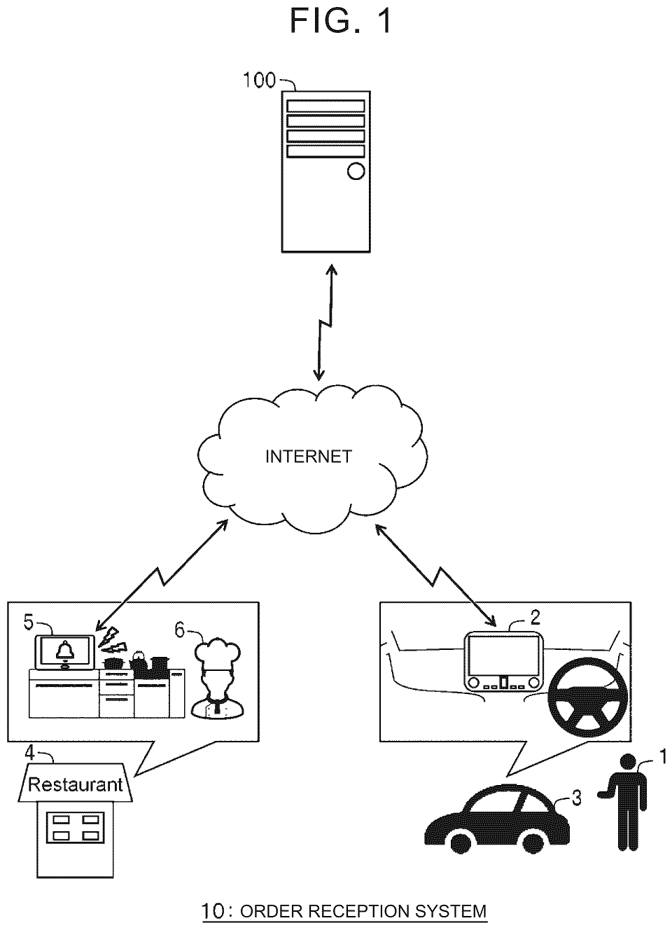

FIG. 1 is a schematic diagram of an order reception system 10 according to the present embodiment. The order reception system 10 provides a function of accepting a reservation for providing cooking from the user 1 to the dish providing place 4, and a function of instructing the dish providing place 4 to start preparing for providing cooking based on the reservation. Here, the reservation of the provision of the dish may include the designation of the specific dish to be provided, or may be only the reservation of the seat of the dish providing place 4. Further, the reservation of the provision of the dish may be a reservation of the takeout.

The function provided by the order reception system 10 is realized by the order reception device 100 executing a process. The order reception device 100 is typically a computer (server) accessible via the Internet. In addition, the order reception device 100 is configured to be able to communicate with the user terminal 2 and the provider terminal 5 provided in the dish providing place 4. FIG. 1 illustrates a configuration in which the order reception device 100 communicates with the user terminal 2 and the provider terminal 5 via the Internet.

First, the order reception device 100 receives a reservation for providing cooking from the user 1 through communication with the user terminal 2. That is, the user 1 makes a reservation using the user terminal 2. For example, the user 1 selects a dish providing place 4 for which a reservation is desired. Thereafter, the user 1 selects a specific dish to be provided. Then, the information on the reservation for the provision of the dish selected by the user 1 is transmitted from the user terminal 2 to the order reception device 100 via the Internet. In this way, the order reception device 100 receives a reservation for providing cooking from the user 1.

Note that the form of the user terminal 2 may be a suitable form depending on the environment to which the order reception system 10 is applied. In FIG. 1, a user terminal 2 provided in a vehicle 3 is shown. In this case, it is assumed that the user 1 is a driver of the vehicle 3. With such a configuration, the user 1 can make a reservation for providing cooking while riding on the vehicle 3, for example, in a case where the user intends to ride on the vehicle 3 and move to the dish providing place 4. In particular, in this case, the order reception device 100 may be configured to accept that the user 1 has set the dish providing place 4 as the destination of the vehicle 3 as a reservation of the dish providing. Thus, the user 1 can simultaneously set the destination of the vehicle 3 and reserve the provision of the cooking. As a result, the usability of the order reception system can be improved with respect to the reservation of the provision of the dish. At this time, the reservation of the provision of the dish is typically a reservation of the seat of the dish providing place 4. However, after the dish providing place 4 is set as the destination, the order reception device 100 may be further configured to accept designation of a specific dish.

Other forms of the user terminal 2 include a mobile terminal (for example, a smartphone) connected to the Internet. In this case, the user terminal 2 may be capable of using a function provided by the order reception system 10 on a predetermined application.

Next, the order reception device 100 receives the reservation of the provision of the cooking, and calculates a lead time required for the provision of the cooking and an arrival time at which the user 1 arrives at the dish providing place 4.

Here, the order reception device 100 calculates the arrival time of the user 1 at the dish providing place 4, for example, based on the information on the current location of the user 1 and the map information. In this case, the order reception device 100 may be configured to acquire information on the current location and map information of the user 1 via the Internet. For example, the order reception device 100 acquires GPS position data from the user terminal 2 via the Internet. In particular, the order reception device 100 may be configured to grasp a congestion state of a route on which the user 1 moves, and calculate an arrival time based on the congestion state of the route.

The arrival time of the user 1 may be calculated by the user terminal 2. In this case, the order reception device 100 may acquire the arrival time from the user terminal 2 via the Internet. In addition, in a case where the dish providing place 4 is set as the destination of the vehicle 3 as the reservation of the provision of the cooking, the order reception device 100 may be configured to calculate the expected time at which the vehicle 3 arrives at the destination as the arrival time of the user 1. In this case, the order reception device 100 may be configured to acquire an estimated time at which the vehicle 3 arrives at the destination from the user terminal 2 via the Internet.

In addition, when the reservation of the provision of the cooking includes the designation of the specific cooking, the order reception device 100 calculates the lead time required for the provision of the cooking, for example, based on the standard lead time determined for each cooking provided at the dish providing place 4. Here, the standard lead time may be an average required time required for cooking. The order reception device 100 may be configured to manage the standard lead time for each dish as a database to be recorded in the storage device. Further, the standard lead time for each dish may be configured such that the cooking provider 6 can set the standard lead time by operating the provider terminal 5.

For example, the order reception device 100 calculates a standard lead time determined for the specified specific cooking as a lead time required for providing the cooking. Alternatively, the order reception device 100 may calculate the lead time by multiplying the standard lead time by a magnification corresponding to the situation of the dish providing place 4. For example, the order reception device 100 may be configured to calculate the lead time by multiplying the standard lead time by a magnification corresponding to the congestion state of the dish providing place 4. In this case, the order reception device 100 may be configured to acquire the congestion status from the provider terminal 5 via the Internet.

In a case where the reservation of the provision of the cooking is a reservation of a seat in the providing place 4 of the cooking and does not include the designation of the specific cooking, the order reception device 100 can calculate the lead time required for the provision of the cooking, for example, based on the average waiting time of the user 1 in the past in the dish providing place 4.

Next, the order reception device 100 instructs the dish providing place 4 to start preparing for providing the cooking by communicating with the provider terminal 5. In particular, the order reception device 100 requests the provider terminal 5 to start preparation for providing cooking at a predetermined timing based on the calculated arrival time of the user 1 and the lead time required for providing cooking. In response to a request from the order reception device 100, the provider terminal 5 instructs the cooking provider 6 to start cooking preparation.

Typically, the order reception device 100 instructs the dish providing place 4 to start preparing to provide the dish at a time before only the lead time required for providing the dish from the arrival time of the user 1. Alternatively, the order reception device 100 may be configured to give an instruction at a timing before and after the reference, taking into consideration variations in the arrival time and the lead time, with the time before the arrival time and only the lead time as a reference. As described above, when an instruction to start preparation for providing cooking is given, the cooking provider 6 starts preparation for cooking according to the instruction, so that it is expected that the cooking can be provided in the vicinity of the time at which the user 1 arrives at the dish providing place 4. As a result, the waiting time after the user 1 arrives at the dish providing place 4 can be reduced. Furthermore, it is expected that the turnover rate can be improved and the congestion situation can be eliminated at the dish providing place 4.

The order reception device 100 may be configured to transmit the arrival time and the lead time calculated via the Internet to the provider terminal 5. In this case, the provider terminal 5 may be configured to instruct the cooking provider 6 of the arrival time and the lead time. With this configuration, the cooking provider 6 can confirm the arrival time and the lead time before and after an instruction to start preparation for cooking.

The vehicle 3 may be an autonomous vehicle. In this case, the vehicle 3 may be configured to autonomously travel toward the dish providing place 4 in response to the user 1 setting the dish providing place 4 as the destination of the vehicle 3. The order reception device 100 may be configured to acquire an estimated time at which the vehicle 3 arrives at the destination by communication with the vehicle 3.

As described above, according to the order reception system 10 of the present embodiment, since the start of preparation for providing cooking is instructed to the dish providing place 4 on the basis of the arrival time of the user 1 and the lead time required for providing cooking, it is possible to reduce the waiting time after the user 1 has arrived at the dish providing place 4.

Hereinafter, a configuration of the order reception system 10 according to the present embodiment will be described with reference to the drawings.

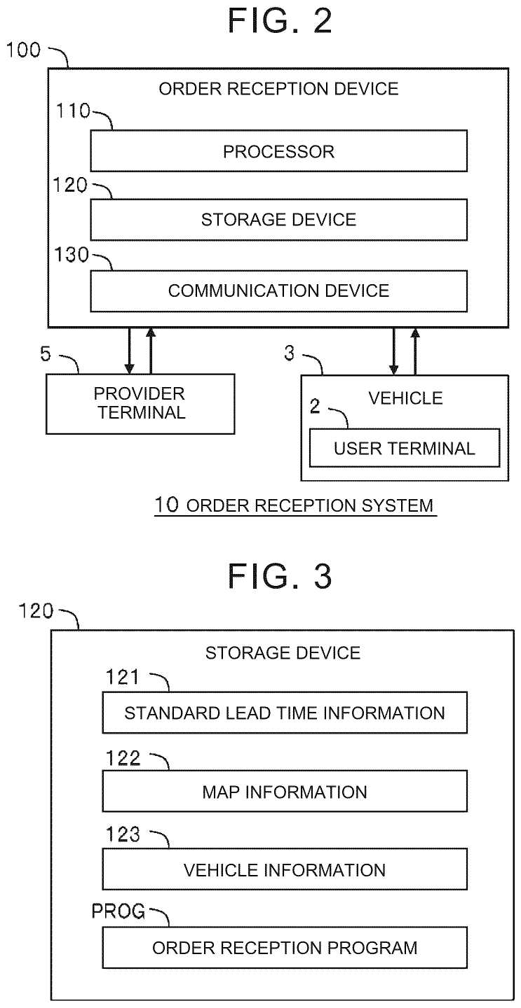

FIG. 2 is a block diagram illustrating a preferred example of the configuration of the order reception system 10. FIG. 2 shows a case where the user terminal 2 is mounted on the vehicle 3.

The order reception device 100 includes one or more processors 110 (hereinafter, simply referred to as processors 110), one or more storage devices 120 (hereinafter, simply referred to as storage devices 120), and a communication device 130.

The processor 110 executes various processes. That is, the processor 110 operates to implement the processing of the order reception device 100. In addition, functions provided by the order reception system 10 are realized. For example, the processor 110 includes a Central Processing Unit (CPU).

The storage device 120 stores various kinds of information necessary for processing by the processor 110. Examples of the storage device 120 include volatile memory, non-volatile memory, Hard Disk Drive (HDD), Solid State Drive (SSD), and the like. The processor 110 reads various kinds of information from the storage device 120 and stores various kinds of information in the storage device 120. In particular, the processor 110 operates according to a program read from the storage device 120. Information stored in the storage device 120 will be described later.

The communication device 130 communicates with an external device of the order reception device 100 to transmit and receive information. In particular, the communication device 130 transmits and receives information to and from the vehicle 3 (or the user terminal 2) and the provider terminal 5. That is, the order reception device 100 communicates with the vehicle 3 (or the user terminal 2) and the provider terminal 5 via the communication device 130. Typically, the communication device 130 is configured to connect to the Internet and communicate with the vehicle 3 (or the user terminal 2) and the provider terminal 5. The communication device 130 receives a reservation for providing cooking, requests an instruction to start preparing for providing cooking, and the like. The information received by the communication device 130 is stored in the storage device 120.

The user terminal 2 may be, for example, a device that functions as a car navigation system. The user terminal 2 is configured to be able to input at least a reservation for providing cooking.

The provider terminal 5 is configured to be able to instruct at least the cooking provider 6. For example, the provider terminal 5 is a tablet terminal having a speaker or a display. In this case, the provider terminal 5 instructs the cooking provider 6 by sound or display. However, the provider terminal 5 may be capable of using a function provided by the order reception system 10 on a predetermined application.

FIG. 3 is a block diagram illustrating a configuration of the storage device 120. The storage device 120 stores standard lead time information 121, map information 122, vehicle information 123, and order reception program PROG.

The standard lead time information 121 is information related to a standard lead time determined for each dish provided at the dish providing place 4. The standard lead time information 121 may be managed as a database. In particular, the standard lead time information 121 may include information of a standard lead time for each dish provided for each of a plurality of dish providing places where the order reception system 10 receives a reservation for providing a dish.

The map information 122 includes information on the location of the dish providing place 4 and road information.

The vehicle information 123 includes information related to the vehicle 3 on which the user 1 rides. For example, it includes a current location, a vehicle speed, a destination, and the like of the vehicle 3.

The order reception program PROG is a program that causes the processor 110 to execute a process related to a function provided by the order reception system 10. In other words, the processor 110 operates in accordance with the order reception program PROG, so that the process related to the function provided by the order reception system 10 is executed.

### 3. Order Reception Method

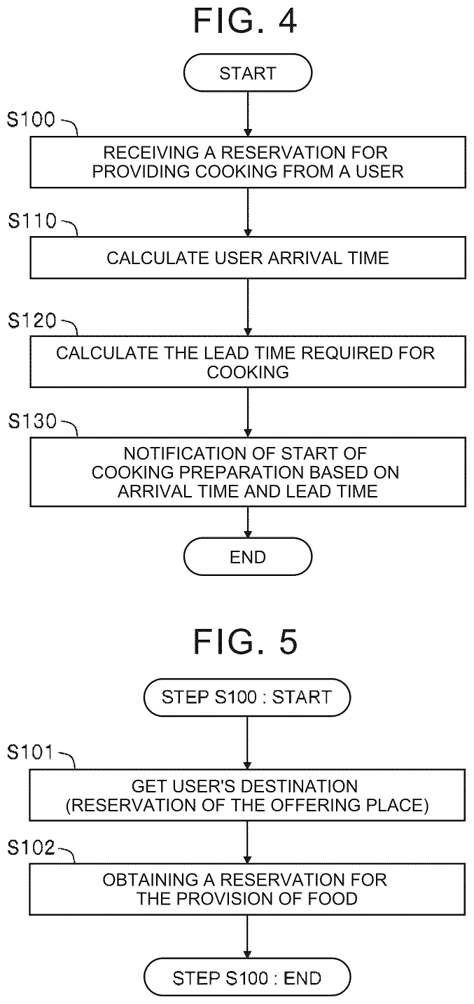

FIG. 4 illustrates an example of a process executed by the order reception device 100 in the order reception system 10, and more specifically, a process executed by the processor 110.

In S100, the order reception device 100 receives an appointment from the user 1 to provide a dish to the dish providing place 4.

In the following S110, the order reception device 100 calculates the arrival time at which the user 1 arrives at the dish providing place 4.

In the following S120, the order reception device 100 calculates a lead time required to provide the dish for the appointment of the dish received by S100. In particular, when the reservation of the provision of the cooking includes the designation of the specific cooking, the order reception device 100 refers to the standard lead time information 121 stored in the storage device 120, and calculates the lead time based on the standard lead time determined for the specific cooking.

In the following S130, the order reception device 100 instructs the dish providing place 4 to start preparing for providing the dish on the basis of the arrival time of the user 1 calculated by S110 and the lead time calculated by S120. Typically, the order reception device 100 instructs the dish providing place 4 to start preparing to provide the dish at a time earlier than the lead time calculated by S120 from the arrival time of the user 1 calculated by S110.

After S130, the process ends. Upon receiving the instruction, the cooking provider 6 can determine the start of preparation for cooking. In particular, when the cooking provider 6 starts preparing the cooking according to the instruction, it can be expected that the cooking can be provided in the vicinity of the time when the user 1 arrives at the dish providing place 4. As a result, the user 1 can reduce the waiting time for cooking at the dish providing place 4.

In this way, the process is executed by the order reception device 100. In this manner, the order reception device 100 realizes an order reception method of receiving a reservation for providing a dish from the user 1 to the dish providing place 4.

### 3-1. Concrete Process of S100

FIG. 5 is a flowchart illustrating an example of a part of processing executed by the order reception device 100 according to the present embodiment. Specifically, FIG. 5 is a flow chart describing a process performed by the order reception device 100 with respect to S100 in detail.

In S101, the order reception device 100 acquires the destination of the user 1, that is, the dish providing place 4.

In S102, the order reception device 100 acquires the designation of the particular dish to be provided by the user 1.

S100 is composed of a S101 and a S102. After S102, the process proceeds to S110.

### 3-2. Specific Configuration of S110

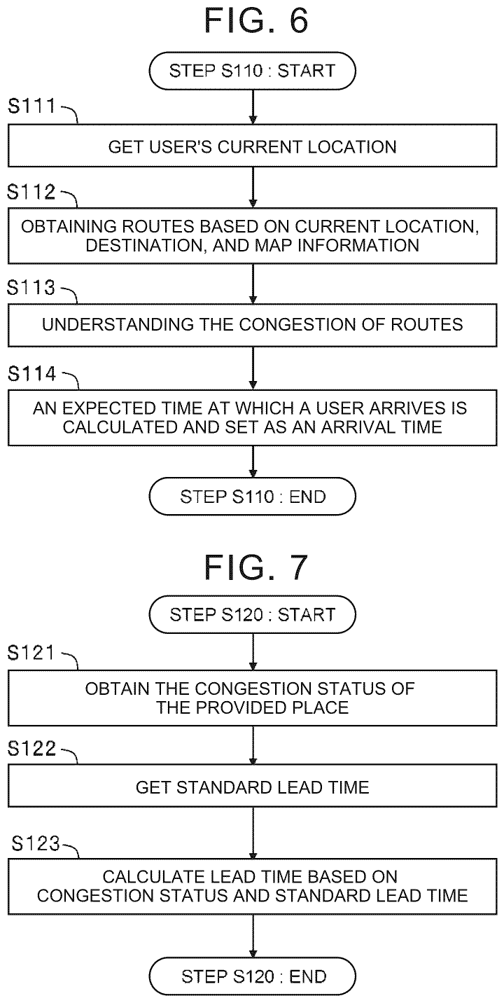

FIG. 6 is a flowchart illustrating an example of a part of processing executed by the order reception device according to the present embodiment. Specifically, FIG. 6 is a flow chart describing a process performed by the order reception device 100 with respect to S110 in detail.

In S111, the order reception device 100 acquires the current location of the user 1. Specifically, the order reception device 100 acquires GPS location data from the user terminal 2 via the Internet and recognizes the location data as the current location of the user 1.

In S112, the order reception device 100 acquires a route traveled by the user 1 based on the current location of the user 1, the destination acquired by S101, and the map-information 122.

In S113, the order reception device 100 grasps the congestion status of the route acquired by S112. For example, a congestion state of a route is acquired from an external traffic information center via the communication device 130.

In S114, the order reception device 100 calculates an expected time at which the user 1 arrives at the dish providing place 4 based on the congestion state grasped by S113, and sets the estimated time as the arrival time of the user 1.

S110 is composed of S111 to S114. After S114, the process proceeds to S120.

### 3-3. Specific Configuration of S120

FIG. 7 is a flowchart illustrating an example of a part of processing executed by the order reception device according to the present embodiment. Specifically, FIG. 7 is a flow chart describing a process performed by the order reception device 100 with respect to S120 in detail.

In S121, the order reception device 100 grasps the congestion status of the dish providing place 4. For example, the order reception device 100 acquires the congestion state input by the cooking provider 6 using the provider terminal 5 via the Internet.

In S122, the order reception device 100 acquires a normal lead time.

In S123, the order reception device 100 calculates the lead time based on the congestion status of the dish providing place 4 and the normal lead time.

S120 is composed of S121 to S123. After S123, the process proceeds to S130.

What is claimed is:

1. An order reception system comprising one or processors, wherein the one or more processors are configured to perform:
a process of receiving a reservation for providing a dish from a user to a providing place of the dish;
a process of calculating, in response to the reservation, a lead time required for providing the dish and an arrival time at which the user arrives at the providing place; and
a process of instructing the providing place to start preparation for providing the dish based on the arrival time and the lead time.

2. The order reception system according to claim 1, wherein:
receiving the reservation by the one or more processors includes receiving, as the reservation, that the user riding in a vehicle has set the providing place as a destination of the vehicle; and
calculating the arrival time by the one or more processors includes determining an expected time at which the vehicle arrives at the destination as the arrival time.

3. The order reception system according to claim 2, wherein:
the vehicle includes a user terminal operated by the user; and
the one or more processors receive the reservation via the user terminal.

4. The order reception system according to claim 1, wherein calculating the arrival time by the one or more processors includes:
grasping a congestion state of a route on which the user moves; and
calculating the arrival time based on the congestion state of the route.

5. The order reception system according to claim 1, wherein calculating the lead time by the one or more processors includes:
grasping a congestion state of the providing place; and
calculating the lead time based on the congestion state of the providing place.

6. The order reception system according to claim 1, wherein:
the reservation includes designating a particular dish to be provided; and
calculating the lead time by the one or more processors includes calculating the lead time based on a standard lead time defined for the particular dish.

7. An order reception method comprising:
receiving a reservation for providing a dish from a user to a providing place of the dish;
calculating, in response to the reservation, a lead time required for providing the dish and an arrival time at which the user arrives at the providing place; and
instructing the providing place to start preparation for providing the dish based on the arrival time and the lead time.

8. A non-transitory storage medium storing an order reception program configured to cause a computer to perform processes comprising:
receiving a reservation for providing a dish from a user to a providing place of the dish;
calculating, in response to the reservation, a lead time required for providing the dish and an arrival time at which the user arrives at the providing place; and
instructing the providing place to start preparation for providing the dish based on the arrival time and the lead time.
